(19) United States
(12) Patent Application Publication
(10) Pub. No.: US 2025/0081105 A1
(43) Pub. Date: Mar. 6, 2025

(54) HANDLING DOWNLINK MESSAGES AT CONNECTED DEVICES

(71) Applicant: QUALCOMM Incorporated, San Diego, CA (US)

(72) Inventors: Jaya Venku Naidu SABBAVARAPU, Hyderabad (IN); Jayapal ARURI, Hyderabad (IN); Vishwadeep PANIGRAHI, Bengaluru (IN)

(21) Appl. No.: 18/461,772

(22) Filed: Sep. 6, 2023

(51) Int. Cl. H04W 52/02; H04W 68/02; H04W 76/10

(52) U.S. Cl. CPC H04W 52/0235; H04W 68/02; H04W 76/10

(57) ABSTRACT

Methods, systems, and devices for wireless communications are described. A wireless device may establish a non-cellular connection with a user equipment (UE) to operate in a connected mode. Additionally, the wireless device and the UE may support cellular connections with a wireless network. If the wireless network sends a downlink message for the wireless device, the wireless device may refrain from receiving the downlink message via a cellular connection with the wireless network. For example, the wireless device may receive a wake-up signal from a network entity, the wake-up signal indicating that a message is available via the cellular connection. Based on operating in the connected mode, the wireless device may receive the message from the UE via the non-cellular connection instead of from the network entity via the cellular connection. In some examples, the UE may send a decoded version of the message to the wireless device.

### FIELD OF TECHNOLOGY

The following relates to wireless communications, including handling downlink messages at connected devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless devices may support non-cellular connections, such as Bluetooth connections. For example, a first wireless device may connect to (e.g., pair with) a second wireless device by establishing a non-cellular connection. The non-cellular connection may support communications between the wireless devices, such as between a UE (e.g., a mobile phone) and a connected wireless device (e.g., a smart watch). If the connected wireless device is also connected to a wireless network via a cellular connection, the cellular connection and the non-cellular connection may potentially introduce redundant processing. In some cases, the wireless device may redundantly decode a same message received via both the cellular connection and the non-cellular connection, increasing the processing overhead and reducing the battery life at the wireless device.

### SUMMARY

The described techniques relate to improved methods, systems, devices, and apparatuses that support handling downlink messages at connected devices. For example, the described techniques provide for improved processing overhead and battery life at a wireless device that supports a non-cellular connection with a user equipment (UE). For example, a wireless device (e.g., a smart watch or other connected device) may establish a non-cellular connection (e.g., a Bluetooth connection) with another wireless device (e.g., a UE, such as a smart phone) to operate in a connected mode. Additionally, the wireless device and the UE may support cellular connections with a wireless network. If a network entity of the wireless network sends a downlink message for the wireless device via a cellular connection, the UE may receive the message and may forward the message to the wireless device via the non-cellular connection. To improve a processing overhead and conserve power, the wireless device may refrain from receiving the downlink message via the cellular connection. For example, the wireless device may receive a wake-up signal from a network entity, where the wake-up signal indicates that the message is available for the wireless device via the cellular connection. Based on operating in the connected mode, the wireless device may refrain from receiving or decoding the message via the cellular connection in response to the wake-up signal and may instead receive the message from the UE via the non-cellular connection. In some examples, the UE may send a decoded version of the message to the wireless device, such that the wireless device may refrain from decoding the message. Such techniques may improve the battery life of the wireless device by reducing the processing resources used for downlink message reception if the wireless device is operating in the connected mode.

A method for wireless communication by a wireless device is described. The method may include establishing a non-cellular connection between the wireless device and a UE, the non-cellular connection supporting operation of the wireless device in a connected mode with the UE, and receiving a wake-up signal from a network entity and via a cellular connection, the wake-up signal indicating that a message is available via the cellular connection. The method may further include receiving the message via the non-cellular connection based on the operation of the wireless device in the connected mode with the UE.

A wireless device is described. The wireless device may include one or more memories storing processor executable code and one or more processors coupled with the one or more memories. The one or more processors may be individually or collectively operable to execute the code to cause the wireless device to establish a non-cellular connection between the wireless device and a UE, the non-cellular connection supporting operation of the wireless device in a connected mode with the UE, and receive a wake-up signal from a network entity and via a cellular connection, the wake-up signal indicating that a message is available via the cellular connection. The one or more processors may be individually or collectively operable to further execute the code to cause the wireless device to receive the message via the non-cellular connection based on the operation of the wireless device in the connected mode with the UE.

Another wireless device for wireless communication is described. The wireless device may include means for establishing a non-cellular connection between the wireless device and a UE, the non-cellular connection supporting operation of the wireless device in a connected mode with the UE, and means for receiving a wake-up signal from a network entity and via a cellular connection, the wake-up signal indicating that a message is available via the cellular connection. The wireless device may further include means for receiving the message via the non-cellular connection based on the operation of the wireless device in the connected mode with the UE.

A non-transitory computer-readable medium storing code for wireless communication is described. The code may include instructions executable by a processor to establish a non-cellular connection between a wireless device and a UE, the non-cellular connection supporting operation of the wireless device in a connected mode with the UE, and receive a wake-up signal from a network entity and via a cellular connection, the wake-up signal indicating that a message is available via the cellular connection. The code may further include instructions executable by the processor to receive the message via the non-cellular connection based on the operation of the wireless device in the connected mode with the UE.

Some examples of the method, wireless devices, and non-transitory computer-readable medium described herein may further include operations, features, means, or instructions for monitoring for the message via the non-cellular connection in accordance with a paging cycle, where the message may be received via the non-cellular connection based on the monitoring.

Some examples of the method, wireless devices, and non-transitory computer-readable medium described herein may further include operations, features, means, or instructions for refraining from performing a wake-up procedure in response to the wake-up signal based on the operation of the wireless device in the connected mode with the UE.

Some examples of the method, wireless devices, and non-transitory computer-readable medium described herein may further include operations, features, means, or instructions for additionally receiving the message via the cellular connection and refraining from decoding the message additionally received via the cellular connection based on the operation of the wireless device in the connected mode with the UE.

Some examples of the method, wireless devices, and non-transitory computer-readable medium described herein may further include operations, features, means, or instructions for refraining from decoding the message received via the non-cellular connection based on the message being decoded at the UE.

In some examples of the method, wireless devices, and non-transitory computer-readable medium described herein, the non-cellular connection includes a Bluetooth connection.

In some examples of the method, wireless devices, and non-transitory computer-readable medium described herein, the wireless device includes a smart watch or a wearable device, and the smart watch or the wearable device may be paired with the UE.

A method for wireless communication by a UE is described. The method may include establishing a non-cellular connection between the UE and a wireless device, the non-cellular connection supporting operation of the wireless device in a connected mode with the UE, and receiving a message via a cellular connection with a network entity, the message associated with the wireless device. The method may further include transmitting the message via the non-cellular connection to the wireless device based on the message being associated with the wireless device and the operation of the wireless device in the connected mode with the UE.

A UE is described. The UE may include one or more memories storing processor executable code and one or more processors coupled with the one or more memories. The one or more processors may be individually or collectively operable to execute the code to cause the UE to establish a non-cellular connection between the UE and a wireless device, the non-cellular connection supporting operation of the wireless device in a connected mode with the UE, and receive a message via a cellular connection with a network entity, the message associated with the wireless device. The one or more processors may be individually or collectively operable to further execute the code to cause the UE to transmit the message via the non-cellular connection to the wireless device based on the message being associated with the wireless device and the operation of the wireless device in the connected mode with the UE.

Another UE for wireless communication is described. The UE may include means for establishing a non-cellular connection between the UE and a wireless device, the non-cellular connection supporting operation of the wireless device in a connected mode with the UE, and means for receiving a message via a cellular connection with a network entity, the message associated with the wireless device. The UE may further include means for transmitting the message via the non-cellular connection to the wireless device based on the message being associated with the wireless device and the operation of the wireless device in the connected mode with the UE.

A non-transitory computer-readable medium storing code for wireless communication is described. The code may include instructions executable by a processor to establish a non-cellular connection between a UE and a wireless device, the non-cellular connection supporting operation of the wireless device in a connected mode with the UE, and receive a message via a cellular connection with a network entity, the message associated with the wireless device. The code may further include instructions executable by the processor to transmit the message via the non-cellular connection to the wireless device based on the message being associated with the wireless device and the operation of the wireless device in the connected mode with the UE.

In some examples of the method, UEs, and non-transitory computer-readable medium described herein, transmitting the message via the non-cellular connection may include operations, features, means, or instructions for transmitting the message via the non-cellular connection in accordance with a paging cycle.

Some examples of the method, UEs, and non-transitory computer-readable medium described herein may further include operations, features, means, or instructions for decoding the message received via the cellular connection, where transmitting the message via the non-cellular connection may include operations, features, means, or instructions for transmitting the decoded message via the non-cellular connection to the wireless device.

Some examples of the method, UEs, and non-transitory computer-readable medium described herein may further include operations, features, means, or instructions for determining to forward the message to the wireless device based on the message including an indicator of the wireless device, where the message may be transmitted via the non-cellular connection based on the determining.

In some examples of the method, UEs, and non-transitory computer-readable medium described herein, the non-cellular connection includes a Bluetooth connection.

In some examples of the method, UEs, and non-transitory computer-readable medium described herein, the wireless device includes a smart watch or a wearable device, and the smart watch or the wearable device may be paired with the UE.

### BRIEF DESCRIPTION OF THE DRAWINGS

FIGS. 1 and 2 show examples of wireless communications systems that support handling downlink messages at connected devices in accordance with one or more aspects of the present disclosure.

FIG. 3 shows an example of a flowchart illustrating a method that supports handling downlink messages at connected devices in accordance with one or more aspects of the present disclosure.

FIG. 4 shows an example of a process flow that supports handling downlink messages at connected devices in accordance with one or more aspects of the present disclosure.

FIGS. 5 and 6 show block diagrams of devices that support handling downlink messages at connected devices in accordance with one or more aspects of the present disclosure.

FIG. 7 shows a block diagram of a communications manager that supports handling downlink messages at connected devices in accordance with one or more aspects of the present disclosure.

FIG. 8 shows a diagram of a system including a device that supports handling downlink messages at connected devices in accordance with one or more aspects of the present disclosure.

FIGS. 9 through 13 show flowcharts illustrating methods that support handling downlink messages at connected devices in accordance with one or more aspects of the present disclosure.

### DETAILED DESCRIPTION

Some wireless communications systems may include wireless devices that support non-cellular connections, such as Bluetooth connections. For example, a first wireless device may connect to (e.g., pair with) a second wireless device by establishing a non-cellular connection. The non-cellular connection may support communications between the wireless devices, such as between a user equipment (UE) (e.g., a mobile phone) and a connected wireless device (e.g., a smart watch). Additionally, or alternatively, a wireless device may support a cellular connection with a wireless network. In some cases, a wireless device may establish both a cellular connection with the wireless network and a non-cellular connection with another wireless device (e.g., a UE). In some such cases, the cellular connection and the non-cellular connection may potentially introduce redundant processing at the wireless device. For example, the wireless device may redundantly decode a same message received via both the cellular connection and the non-cellular connection, potentially increasing the processing overhead and reducing the battery life at the wireless device.

The wireless device (e.g., a smart watch or other connected device) may support techniques to efficiently handle downlink messages if the wireless device is operating in a connected mode. For example, the wireless device may be connected to both the wireless network via a cellular connection and a UE (e.g., a second wireless device) via a non-cellular connection. If a network entity of the wireless network sends a downlink message for the wireless device via the cellular connection, the UE may receive the message and may forward the message to the wireless device via the non-cellular connection. To improve a processing overhead and conserve power, the wireless device may refrain from receiving the downlink message via the cellular connection. For example, the wireless device may receive a wake-up signal from a network entity, where the wake-up signal indicates that the message is available for the wireless device via the cellular connection. Based on operating in the connected mode, the wireless device may refrain from receiving or decoding the message via the cellular connection in response to the wake-up signal and may instead receive the message from the UE via the non-cellular connection. The wireless device may avoid redundant processing—and, correspondingly, improve a processing overhead and battery life—by receiving the message via the non-cellular connection with the UE and refraining from receiving or decoding the message via the cellular connection with the wireless network.

In some examples, the UE may send a decoded version of the message to the wireless device via the non-cellular connection (e.g., a Bluetooth connection), such that the wireless device may determine the message contents without decoding the message. Additionally, or alternatively, the wireless device may receive the message from the UE in accordance with a paging cycle for the non-cellular connection. For example, the wireless device may wake up and monitor for one or more messages sent as paging messages via the non-cellular connection based on a Bluetooth paging cycle.

Aspects of the disclosure are initially described in the context of wireless communications systems. Aspects of the disclosure are further illustrated by and described with reference to process flows, apparatus diagrams, system diagrams, and flowcharts that relate to handling downlink messages at connected devices.

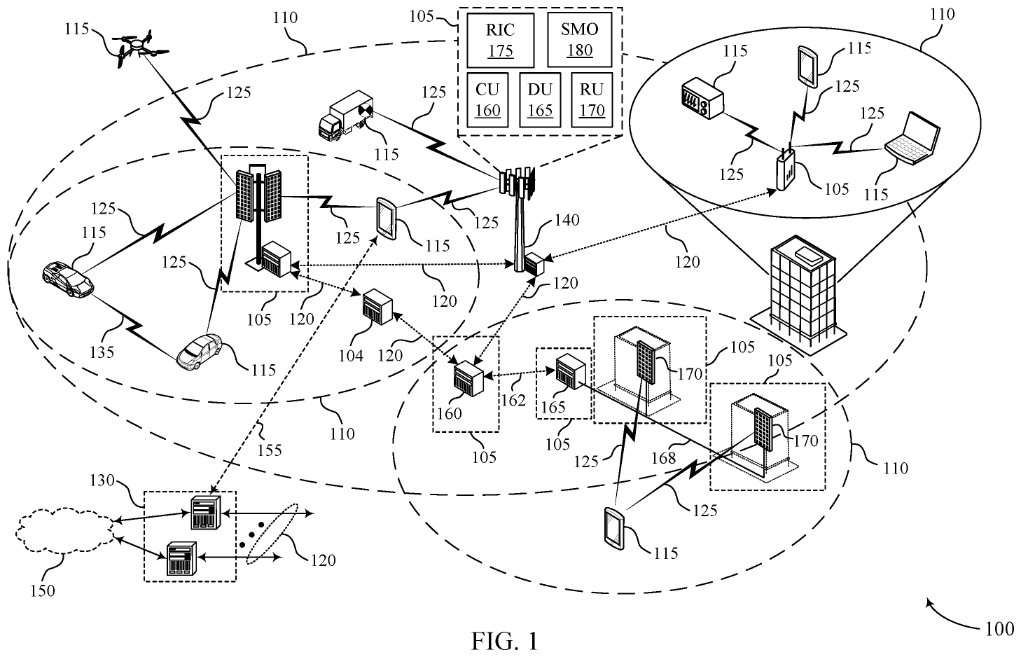

FIG. 1 shows an example of a wireless communications system 100 that supports handling downlink messages at connected devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support handling downlink messages at connected devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, wireless devices within the wireless communications system 100 may additionally support non-cellular connections. For example, a wireless device (e.g., a UE 115) may support a cellular connection with a network entity 105. The cellular connection may be an example of a wireless connection supporting communications in accordance with a cellular RAT, such as LTE, LTE-A, LTE-A Pro, NR, or any other cellular RAT. The wireless device may additionally support a non-cellular connection with another wireless device. The non-cellular connection may be an example of a wireless connection (e.g., a D2D connection) supporting communications in accordance with a non-cellular RAT, such as Bluetooth, Wi-Fi, or any other non-cellular RAT. For example, a smart watch (e.g., a first UE 115) may connect to the wireless network via a cellular connection and may additionally connect to a smart phone (e.g., a second UE 115) via a non-cellular connection.

Wireless devices, such as UEs 115, may include Bluetooth-enabled devices capable of pairing with other Bluetooth-enabled devices, which may include wireless audio devices (e.g., headsets, earbuds, speakers, ear pieces, headphones), display devices (e.g., TVs, computer monitors), microphones, meters, valves, or any other devices. Bluetooth communications may refer to a short-range communication protocol and may be used to connect and exchange information between wireless devices (e.g., between mobile phones, computers, smart watches or other wearables, digital cameras, wireless headsets, speakers, keyboards, mice or other input peripherals, and similar devices). Bluetooth systems may be organized using a primary-secondary relationship employing a time-division duplex protocol having, for example, defined time slots of 625 mu seconds, in which transmission alternates between the primary device (e.g., a smart phone) and one or more secondary devices (e.g., a paired device, such as a smart watch). In some examples, a UE 115 may generally refer to a primary device, and a wireless device may refer to a secondary device in the wireless communications system 100. However, the primary device and the secondary device may each be examples of a wireless device, a UE 115, or both. Additionally, a wireless device may be referred to as a connected device or a device operating in a connected mode based on the Bluetooth role configuration of the device. That is, designation of a wireless device as a connected device may not indicate a distinction in device capability, but rather may refer to or indicate roles held by the wireless device in the wireless communications system 100.

A Bluetooth-enabled device may be compatible with specific Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a specific way and may include information such as suggested user interface formats, options and parameters at each layer of the Bluetooth protocol stack, or the like. For example, a Bluetooth specification may include various profiles that define the behavior associated with each communication endpoint to implement a specific use case. Profiles may be defined according to a protocol stack that promotes and allows interoperability between endpoint devices from different manufacturers through enabling applications to discover and use services that other nearby Bluetooth-enabled devices may be offering. The Bluetooth specification defines device role pairs (e.g., roles for a wireless device connected with a UE 115) that together form a single use case called a profile (e.g., for communications between the wireless device and the UE 115). One example profile defined in the Bluetooth specification is the Handsfree Profile (HFP) for voice telephony, in which one device implements an Audio Gateway (AG) role and the other device implements a Handsfree (HF) device role. Another example is the Advanced Audio Distribution Profile (A2DP) for high-quality audio streaming, in which one device implements an audio source device (SRC) role and another device implements an audio sink device (SNK) role.

For a commercial Bluetooth-enabled device that implements one role in a profile to function properly, another device that implements the corresponding role may be present within the radio range of the first device. For example, for an HF device such as a Bluetooth headset to function according to the Handsfree Profile, a device implementing the AG role (e.g., a cell phone) may be present within radio range. Likewise, to stream high-quality mono or stereo audio according to the A2DP, a device implementing the SNK role (e.g., Bluetooth headphones or Bluetooth speakers) may be within radio range of a device implementing the SRC role (e.g., a stereo music player).

The Bluetooth specification defines a layered data transport architecture and various protocols and procedures to handle data communicated between two devices that implement a specific profile use case. For example, various logical links are available to support different application data transport thresholds, with each logical link associated with a logical transport having specific characteristics (e.g., flow control, acknowledgment mechanisms, repeat mechanisms, sequence numbering, scheduling behavior). The Bluetooth protocol stack may be split in two parts: a controller stack including the timing critical radio interface, and a host stack handling high level data. The controller stack may be implemented in a relatively low cost silicon device including a Bluetooth radio and a microprocessor. The controller stack may be responsible for setting up connection links such as asynchronous connection-less (ACL) links, (or ACL connections), synchronous connection-oriented (SCO) links (or SCO connections), extended synchronous connection-oriented (eSCO) links (or eSCO connections), or other logical transport channel links.

In some examples, the controller stack may implement link management protocol (LMP) functions, low energy link layer (LELL) functions, or other supported functions. The host stack may be implemented as part of an operating system or as an installable package on top of an operating system. The host stack may be responsible for logical link control and adaptation protocol (L2CAP) functions, Bluetooth network encapsulation protocol (BNEP) functions, service discovery protocol (SDP) functions, or other functions. In some examples, the controller stack and the host stack may communicate via a host controller interface (HCl). In some other examples (e.g., for integrated devices such as Bluetooth headsets), the host stack and controller stack may run on the same microprocessor to reduce mass production costs. For such host-less systems, the HCl may be optional and may be implemented as an internal software interface.

One or more wireless devices may establish a non-cellular connection, such as a D2D communication link 135, between two Bluetooth-enabled devices (e.g., between two UEs 115) and may provide for communications or services (e.g., according to some Bluetooth profile). For example, a Bluetooth connection may be an eSCO connection for voice call (e.g., which may allow for retransmission), an ACL connection for music streaming (e.g., A2DP), or another type of Bluetooth connection. For example, eSCO packets may be transmitted in predetermined time slots (e.g., 6 Bluetooth slots each for eSCO). The regular interval between the eSCO packets may be specified when the Bluetooth link is established. The eSCO packets communicated with a specific secondary device (e.g., a connected wireless device) may be acknowledged and may be retransmitted if not acknowledged during a retransmission window. Additionally, or alternatively, audio may be streamed between a UE 115 and a connected wireless device using an ACL connection (A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (e.g., providing reduced power consumption and cost while maintaining a similar communication range), human interface device profile (HID) (e.g., providing low latency links with low power thresholds), or other Bluetooth profiles.

In some examples, a wireless device supporting a Bluetooth connection may be an example of a battery-powered device. Power optimization and battery lifetime may be important for battery-powered device usage. For example, the wireless device may be an example of a wearable device within an IoT system, such as a smart watch. Some smart watch batteries may support a capacity of up to 400 to 600 milliampere hours (mAH) for 3.7 Volts (V). Optimizing—or otherwise improving—battery resource usage for the smart watch may allow the smart watch to allocate such battery resources for other activities, extend the average battery life of the smart watch, or both. For example, continuous modem activities at the smart watch may consume battery resources at the smart watch.

For example, the smart watch (e.g., a wireless device, a first UE 115) may be connected with a smart phone (e.g., a second UE 115) using a Bluetooth connection or another non-cellular connection. Additionally, the smart watch and the smart phone may be connected to a wireless network using respective cellular connections (e.g., communication links 125). The smart watch and the smart phone (e.g., the companion mobile device for the smart watch) may be capable of receiving a same message via the cellular connections, such as LTE communication links 125. For example, the wireless network may send a set of messages to both the smart watch and the smart phone, the set of messages (e.g., in some cases, 20 to 30 messages per day, on average) including promotional messages, data packets, banking information, service packages, shopping information, sports information, personal texts, or any combination of these or other messages. If both the smart watch and smart phone receive and parallelly decode the same message (e.g., the same downlink message from the wireless network), the smart watch, smart phone, or both may inefficiently consume power for redundant processing. In some cases, decoding the message at the smart watch may consume relatively more power than decoding the message at the smart phone. Avoiding such dual decoding at both the smart watch and smart phone may support battery savings at the smart watch, the smart phone, or both.

The smart watch (e.g., a UE 115) may support techniques to efficiently handle downlink messages if the smart watch is operating in a connected mode with a companion mobile device (e.g., a smart phone, another UE 115). For example, if a network entity 105 of the wireless network sends a downlink message for the smart watch via a cellular connection, the companion mobile device may receive the message and may forward the message to the smart watch via the non-cellular connection. To improve a processing overhead and conserve power, the smart watch may refrain from receiving the downlink message via the cellular connection. Based on operating in the connected mode, the smart watch may instead receive the message from the companion mobile device via the non-cellular connection. The smart watch may avoid redundant processing—and, correspondingly, improve a processing overhead and battery life—by receiving the message via the non-cellular connection with the companion mobile device and refraining from receiving or decoding the message via the cellular connection with the wireless network (e.g., with the network entity 105).

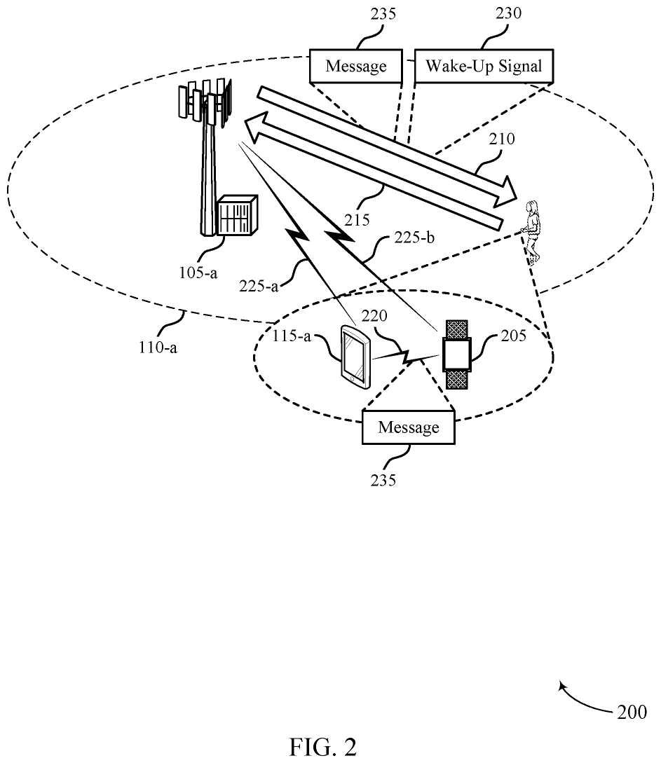

FIG. 2 shows an example of a wireless communications system 200 that supports handling downlink messages at connected devices in accordance with one or more aspects of the present disclosure. The wireless communications system 200 may be an example of a wireless communications system 100 as described with reference to FIG. 1. The wireless communications system 200 may include a network entity 105-a, which may be an example of a network entity 105 (e.g., a CU, a DU, an RU, a core network entity, or any combination of these or other network devices) as described with reference to FIG. 1. The network entity 105-a may provide network coverage for a coverage area 110-a. The network entity 105-a may communicate, via a downlink channel 210, an uplink channel 215, or both, with a UE 115-a, a wireless device 205, or both, which may be examples of UEs 115 as described with reference to FIG. 1. For example, the wireless device 205 may be an example of a wearable device (e.g., a smart watch), a connected device, or any other device that supports a non-cellular connection 220 with the UE 115-a. The wireless communications system 200 may support techniques for the wireless device 205 to efficiently receive a message 235 from the wireless network when the wireless device 205 is operating in a connected mode with the UE 115-a.

The network entity 105-a may communicate with the UE 115-a, the wireless device 205 (e.g., another UE 115 or other wireless device), or both. For example, the network entity 105-a may transmit signals to the UE 115-a, the wireless device 205, or both via a downlink channel 210. Additionally, or alternatively, the network entity 105-a may receive signals from the UE 115-a, the wireless device 205, or both via an uplink channel 215. In some examples, the network entity 105-a may be an example or a component of a base station or other network device providing a cellular network connection for the UE 115-a, the wireless device 205, or both. The network entity 105-a, the UE 115-a, or both may establish a cellular connection 225-a between the network entity 105-a and the UE 115-a. Similarly, the network entity 105-a, the wireless device 205, or both may establish a cellular connection 225-b between the network entity 105-a and the wireless device 205. As such, both the UE 115-a and the wireless device 205 may communicate with the wireless network via cellular connections.

In some cases, the UE 115-a, the wireless device 205, or both may additionally establish a non-cellular connection 220 between the UE 115-a and the wireless device 205. For example, the wireless device 205 may be an example of a smart watch, and the UE 115-a may be an example of a smart phone. The wireless device 205 (e.g., the smart watch) may pair with the UE 115-a (e.g., the smart phone) using a Bluetooth connection or other non-cellular connection 220. Such a non-cellular connection 220 may support continuous connectivity between the wireless device 205 and the UE 115-a. The wireless device 205 may be in a connected mode with the UE 115-a while the non-cellular connection 220 between the wireless device 205 and the UE 115-a is active.

The non-cellular connection 220 may support a level of redundancy with the cellular connection 225-b for the wireless device 205. For example, if the network entity 105-a transmits—or otherwise sends—a message 235 via the downlink channel 210, the wireless device 205 may support reception of the message 235 using the cellular connection 225-b. However, additionally, the UE 115-a may receive the message 235 using the cellular connection 225-a and may forward the message 235 to the wireless device 205 using the non-cellular connection 220 (e.g., a Bluetooth connection) based on one or more connected mode services. Accordingly, the same message 235 carrying the same information may be available to the wireless device 205 via both network and UE connections (e.g., both the cellular connection 225-b and the non-cellular connection 220).

To improve the processing overhead and battery life at the wireless device 205, the wireless device 205 may efficiently handle such redundant messaging when operating in a connected mode (e.g., when paired or otherwise connected with a UE 115-a via a non-cellular connection 220). For example, the wireless device 205 may refrain from decoding (e.g., in parallel) both the message 235 sent via the cellular connection 225-b and the message 235 (e.g., the same message 235) sent via the non-cellular connection 220. Additionally, or alternatively, the wireless device 205 may refrain from receiving both the message 235 sent via the cellular connection 225-b and the message 235 sent via the non-cellular connection 220. By refraining to perform one or more of these processes, the wireless device 205 may conserve processing resources and battery life.

The UE 115-a may receive one or more messages from the wireless network. The UE 115-a may determine which messages to forward to the wireless device 205 via the non-cellular connection 220. In some examples, a message 235 may include an identifier indicating that the message 235 is to be sent to the wireless device 205. In some cases, the identifier may be an example of a device identifier or UE identifier for the wireless device 205. The UE 115-a may determine to forward the message 235 to the wireless device 205 based on the message including the identifier indicating the wireless device 205.

The UE 115-a may send the same messages to the wireless device 205 via the non-cellular connection 220 as the wireless network sends to the wireless device 205 via the cellular connection 225-b. In some cases, the wireless device 205 may receive the messages from the UE 115-a via the non-cellular connection 220 based on the wireless device 205 supporting a continuous Bluetooth pairing connection with the UE 115-a (e.g., a companion mobile phone). Accordingly, while operating in the connected mode, the wireless device 205 may receive, from the UE 115-a, messages initially sent from the wireless network for the wireless device 205 without significant delay (e.g., within a threshold time window). When operating in the connected mode, the wireless device 205 may receive messages from the UE 115-a using the non-cellular connection 220 (e.g., the Bluetooth connection) and may refrain from receiving or decoding messages (e.g., the same messages) from the network entity 105-a using the cellular connection 225-b.

For example, the wireless device 205 may operate in a sleep state while in idle mode. While operating in the sleep state, the wireless device 205 may conserve processing resources and battery life as compared to an active or awake state. If the wireless network has information to send to the wireless device 205, the network entity 105-a may transmit—or otherwise send—a wake-up signal 230. The wake-up signal 230 may indicate that a message 235 is available for the wireless device 205 via the cellular connection 225-b. The wireless device 205 may detect the wake-up signal (e.g., using a wake-up radio, a low power radio, or other receiver). In some examples, based on the wireless device 205 operating in the connected mode with the UE 115-a, the wireless device 205 may refrain from waking up to receive the message 235 via the cellular connection 225-b in response to the wake-up signal 230. In some other examples, the wireless device 205 may wake up in response to the wake-up signal 230 but may refrain from monitoring for the message 235. In yet some other examples, the wireless device 205 may wake up in response to the wake-up signal 230 and may receive the corresponding message 235. However, the wireless device 205 may refrain from decoding the message 235 based on operating in the connected mode.

The wireless device 205 may instead receive the message 235 from the UE 115-a via the non-cellular connection 220. In some examples, the wireless device 205 may wake up and receive the message 235 from the UE 115-a in response to the wake-up signal 230. In some cases, the UE 115-a may receive the message 235 from the network and may transmit the message 235 to the wireless device 205 via a next available resource. In some other cases, the UE 115-a may transmit the message 235 to the wireless device 205 in a next paging cycle occasion. For example, the non-cellular connection 220 may support a Bluetooth paging cycle, in which paging messages may be sent via a Bluetooth connection at intervals in accordance with a cycle length. The UE 115-a may send one or more messages, including the message 235, to the wireless device 205 via resources of an occasion defined by the paging cycle. The wireless device 205 may conserve power and processing resources by waking up and receiving one or more messages from the UE 115-a via the non-cellular connection 220 at intervals defined by the paging cycle. The wireless device 205 (e.g., a modem of the wireless device 205) may otherwise operate in a sleep state to conserve power.

In some examples, the UE 115-a may forward the message 235 as an encoded message to the wireless device 205. The wireless device 205 may receive the encoded message 235 and decode the message 235 to determine the message contents. In some other examples, the UE 115-a may forward the message 235 as a decoded message to the wireless device 205. For example, the UE 115-a may receive and decode the message 235. Based on the non-cellular connection 220 being an example of a secure connection between the UE 115-a and the wireless device 205, the UE 115-a may transmit the decoded message 235 to the wireless device 205. The wireless device 205 may receive the decoded message 235 and may determine the message contents without performing a further decoding process. The wireless device 205 may save battery resources and improve processing overhead by refraining from (e.g., disabling) decoding of the message 235 at the wireless device 205. For example, rather than dual decoding the same message 235 at both the UE 115-a and the wireless device 205, the UE 115-a may perform the decoding process and may provide the already decoded message 235 to the wireless device 205 using the non-cellular connection 220. Accordingly, the wireless device 205 may receive the downlink message and determine the message contents using the non-cellular connection 220 when operating in the connected mode.

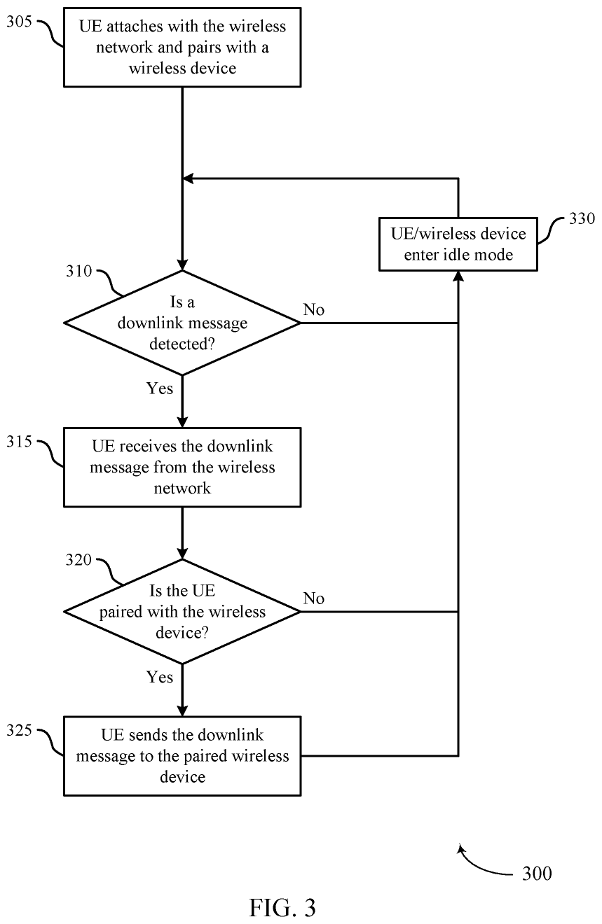

FIG. 3 shows an example of a flowchart illustrating a method 300 that supports handling downlink messages at connected devices in accordance with one or more aspects of the present disclosure. A wireless communications system, such as the wireless communications system 100 or the wireless communications system 200 as described with reference to FIGS. 1 and 2, may support the method 300. For example, a UE 115, such as a UE 115-a as described with reference to FIG. 2, may perform one or more operations of the method 300. Additionally, or alternatively, a wireless device (e.g., a connected device, a wearable device, or a UE 115), such as the wireless device 205 as described with reference to FIG. 2, may perform one or more operations of the method 300.

At 305, the UE 115 may attach to a wireless network. For example, the UE 115 may establish a wireless connection, such as a cellular connection (e.g., an LTE connection, an NR connection) with the wireless network via a network entity 105. Additionally, the UE 115 may pair with a wireless device, such as a smart watch. The UE 115 may pair with the wireless device by establishing a non-cellular connection, such as a Bluetooth connection, with the wireless device.

At 310, the UE 115 may determine whether a downlink message is detected from the wireless network. For example, the UE 115 may monitor for one or more messages from a network entity 105. If the UE 115 operates in a discontinuous reception (DRX) mode, the UE 115 may wake up from an idle mode (e.g., a sleep mode or other relatively low power mode) according to a DRX cycle to monitor for downlink messages. If the UE 115 fails to detect a downlink message, the UE 115 may reenter an idle mode at 330. Alternatively, if the UE 115 detects a downlink message, the UE 115 may receive the downlink message from the wireless network (e.g., from a network entity 105) at 315.

At 320, the UE 115 may determine whether the UE 115 is paired with a wireless device. Additionally, the UE 115 may determine whether the received downlink message indicates the wireless device. For example, the downlink message may indicate a device identifier of the wireless device as a target destination (e.g., an intended target) for the downlink message. If the UE 115 is not paired with the wireless device, or if the downlink message does not indicate the wireless device, the UE 115 may reenter an idle mode at 330. Alternatively, if the UE 115 is paired with the wireless device, the downlink message indicates the wireless device, or both, the UE 115 may transmit (e.g., forward) the downlink message to the paired wireless device via the non-cellular connection at 325. The UE 115 may reenter the idle mode at 330 based on forwarding the message to the wireless device or based on receiving confirmation that the wireless device successfully received the message via the non-cellular connection. For example, in some cases, the wireless device may provide feedback information for the message, such that the UE 115 may resend the message via the non-cellular connection if the wireless device fails to successfully receive the message. In some examples, the wireless device may receive or decode the message from the wireless network (e.g., via a cellular connection) if the wireless device fails to successfully receive the message from the UE 115 a threshold quantity of times (e.g., one failure or multiple failures). In some examples, the wireless device may additionally, or alternatively, enter an idle mode at 330 based on successfully receiving the message from the UE 115 via the non-cellular connection.

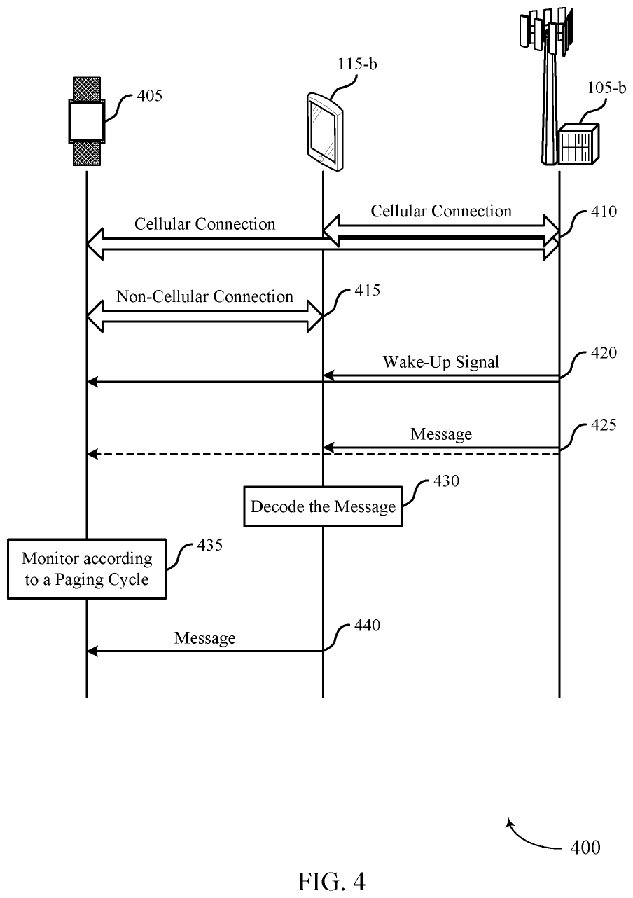

FIG. 4 shows an example of a process flow 400 that supports handling downlink messages at connected devices in accordance with one or more aspects of the present disclosure. In some examples, the process flow 400 may be implemented by aspects of the wireless communications system 100 or the wireless communications system 200 as described with reference to FIGS. 1 and 2. For example, the process flow 400 may include a network entity 105-b (e.g., a CU, a DU, an RU, a core network entity, or any combination thereof), a UE 115-b, and a wireless device 405, which may be respective examples of a network entity 105, a UE 115, and a wireless device (e.g., a connected device, a wearable device, or a UE 115) as described herein with reference to FIGS. 1 through 3. In the following description of the process flow 400, the operations between the devices may be performed in different orders or at different times. Some operations may be left out of the process flow 400, or other operations may be added. Although the network entity 105-b, the UE 115-b, and the wireless device 405 are shown performing the operations of the process flow 400, some aspects of some operations may be performed by one or more other devices or entities.

At 410, the UE 115-b may establish a first cellular connection with a wireless network, for example, via a network entity 105-b. Additionally, the wireless device 405 may establish a second cellular connection with the wireless network, for example, via the network entity 105-b. At 415, the wireless device 405, the UE 115-b, or both may establish a non-cellular connection between the wireless device 405 and the UE 115-b. The non-cellular connection may support operation of the wireless device 405 in a connected mode (e.g., a paired mode) with the UE 115-b. The non-cellular connection may be an example of a Bluetooth connection. In some examples, the wireless device 405 may be an example of a smart watch or other wearable device paired with the UE 115-b, which may be an example of a smart phone or other companion device.

At 420, the wireless network may determine that a message is pending for transmission to the wireless device 405. The network entity 105-b may send a wake-up signal indicating that the message is available via a cellular connection. For example, the wake-up signal may trigger one or more devices to wake up from a relatively low power mode to monitor for the message via a downlink channel. In some cases, the wake-up signal may indicate one or more resources for reception of the message via the downlink channel. The wireless device 405 may receive the wake-up signal via the second cellular connection (e.g., from the network entity 105-b). In some cases, the UE 115-b may additionally receive the wake-up signal via the first cellular connection.

At 425, the network entity 105-b may send the message via the downlink channel in one or more resources indicated by the wake-up signal. The UE 115-b may receive the message via the first cellular connection with the network entity 105-b. The message may be associated with the wireless device 405. For example, the UE 115-b may determine that the message is associated with the wireless device 405 based on the message including an indicator of the wireless device 405. However, in some examples, the wireless device 405 may refrain from performing a wake-up procedure in response to the wake-up signal based on operation of the wireless device 405 in the connected mode with the UE 115-b. In some such examples, the wireless device 405 may refrain from receiving the message via the second cellular connection based on refraining from performing the wake-up procedure. In some other examples, the wireless device 405 may additionally receive the message via the second cellular connection, but the wireless device 405 may refrain from decoding the message received via the cellular connection based on the operation of the wireless device 405 in the connected mode with the UE 115-b.

At 430, the UE 115-b may decode the message received from the wireless network via the first cellular connection. At 435, the wireless device 405 may monitor for the message via the non-cellular connection in accordance with a paging cycle. At 440, the UE 115-b may transmit the message via the non-cellular connection to the wireless device 405 based on the message being associated with the wireless device 405 and the operation of the wireless device 405 in the connected mode with the UE 115-b. In some cases, the UE 115-b may transmit the message via the non-cellular connection in accordance with the paging cycle. The wireless device 405 may receive the message via the non-cellular connection based on the operation of the wireless device 405 in the connected mode with the UE 115-b. In some examples, the UE 115-b may transmit the message as a decoded message, and the wireless device 405 may refrain from decoding the message received via the non-cellular connection based on the message being already decoded by the UE 115-b. Accordingly, the wireless device 405 may receive the message via the non-cellular connection with the UE 115-b instead of from the network entity 105-b via the second cellular connection, avoiding redundant decoding of the same message at the wireless device 405.

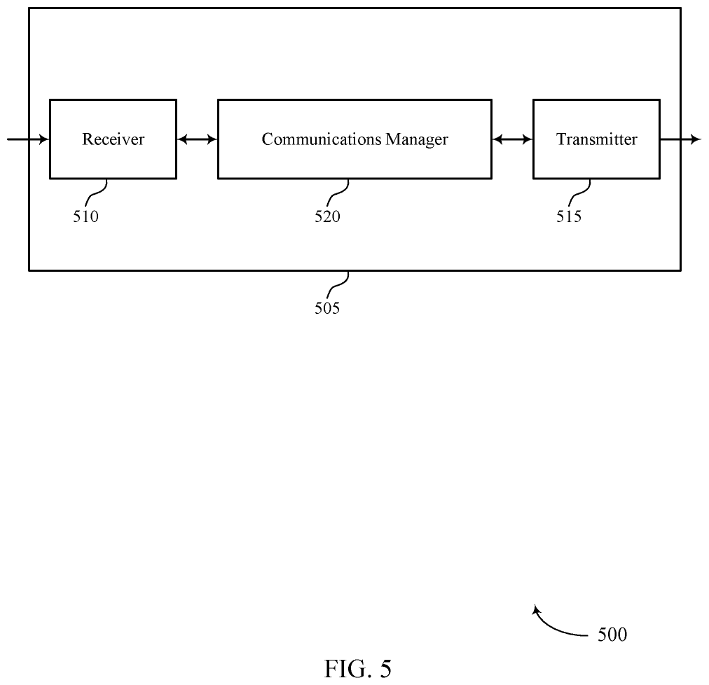

FIG. 5 shows a block diagram 500 of a device 505 that supports handling downlink messages at connected devices in accordance with one or more aspects of the present disclosure. The device 505 may be an example of aspects of a UE 115 or a wireless device as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to handling downlink messages at connected devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to handling downlink messages at connected devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of handling downlink messages at connected devices as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for establishing a non-cellular connection between a wireless device (e.g., the device 505) and a UE, the non-cellular connection supporting operation of the wireless device in a connected mode with the UE. The communications manager 520 is capable of, configured to, or operable to support a means for receiving a wake-up signal from a network entity and via a cellular connection, the wake-up signal indicating that a message is available via the cellular connection. The communications manager 520 is capable of, configured to, or operable to support a means for receiving the message via the non-cellular connection based on operation of the wireless device in the connected mode with the UE.

Additionally, or alternatively, the communications manager 520 may support wireless communication in accordance with examples as disclosed herein. For example, the communications manager 520 is capable of, configured to, or operable to support a means for establishing a non-cellular connection between a UE (e.g., the device 505) and a wireless device, the non-cellular connection supporting operation of the wireless device in a connected mode with the UE. The communications manager 520 is capable of, configured to, or operable to support a means for receiving a message via a cellular connection with a network entity, the message associated with the wireless device. The communications manager 520 is capable of, configured to, or operable to support a means for transmitting the message via the non-cellular connection to the wireless device based on the message being associated with the wireless device and operation of the wireless device in the connected mode with the UE.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing overhead, reduced power consumption, or both for the device 505 (e.g., a wireless device operating in a connected mode with a UE 115). For example, the device 505 may receive a message via a non-cellular connection with the UE 115 and may refrain from receiving the same message via a cellular connection, refrain from decoding the same message via the cellular connection, or both, effectively reducing processing overhead and power consumption at the device 505. In some examples, the message received via the non-cellular connection may be already decoded at the UE 115, further reducing processing associated with decoding operations at the device 505.

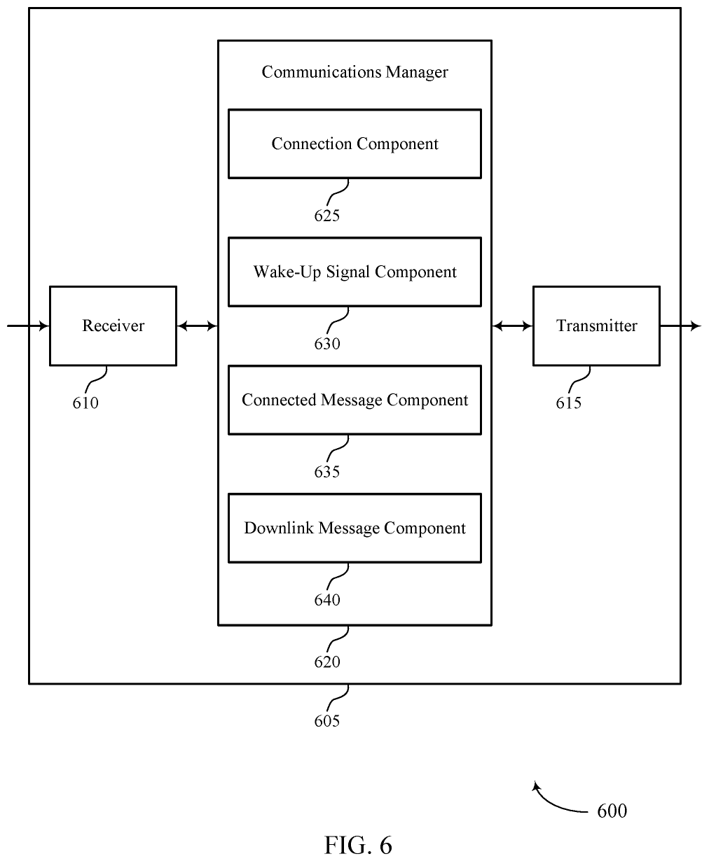

FIG. 6 shows a block diagram 600 of a device 605 that supports handling downlink messages at connected devices in accordance with one or more aspects of the present disclosure. The device 605 may be an example of aspects of a device 505, a UE 115, a wireless device, or any combination thereof as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to handling downlink messages at connected devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to handling downlink messages at connected devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of handling downlink messages at connected devices as described herein. For example, the communications manager 620 may include a connection component 625, a wake-up signal component 630, a connected message component 635, a downlink message component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The connection component 625 is capable of, configured to, or operable to support a means for establishing a non-cellular connection between a wireless device (e.g., the device 605) and a UE, the non-cellular connection supporting operation of the wireless device in a connected mode with the UE. The wake-up signal component 630 is capable of, configured to, or operable to support a means for receiving a wake-up signal from a network entity and via a cellular connection, the wake-up signal indicating that a message is available via the cellular connection. The connected message component 635 is capable of, configured to, or operable to support a means for receiving the message via the non-cellular connection based on operation of the wireless device in the connected mode with the UE.

Additionally, or alternatively, the communications manager 620 may support wireless communication in accordance with examples as disclosed herein. The connection component 625 is capable of, configured to, or operable to support a means for establishing a non-cellular connection between a UE (e.g., the device 605) and a wireless device, the non-cellular connection supporting operation of the wireless device in a connected mode with the UE. The downlink message component 640 is capable of, configured to, or operable to support a means for receiving a message via a cellular connection with a network entity, the message associated with the wireless device. The connected message component 635 is capable of, configured to, or operable to support a means for transmitting the message via the non-cellular connection to the wireless device based on the message being associated with the wireless device and operation of the wireless device in the connected mode with the UE.

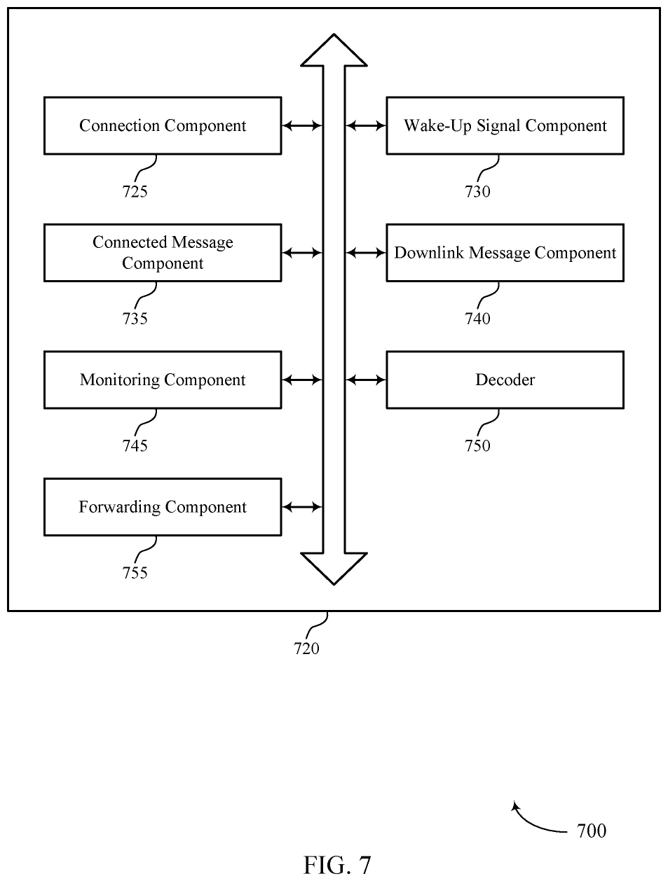

FIG. 7 shows a block diagram 700 of a communications manager 720 that supports handling downlink messages at connected devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of handling downlink messages at connected devices as described herein. For example, the communications manager 720 may include a connection component 725, a wake-up signal component 730, a connected message component 735, a downlink message component 740, a monitoring component 745, a decoder 750, a forwarding component 755, or any combination thereof. Each of these components, or components or subcomponents thereof (e.g., one or more processors, one or more memories), may communicate, directly or indirectly, with one another (e.g., via one or more buses).

The communications manager 720 may support wireless communication at a wireless device in accordance with examples as disclosed herein. The connection component 725 is capable of, configured to, or operable to support a means for establishing a non-cellular connection between the wireless device and a UE, the non-cellular connection supporting operation of the wireless device in a connected mode with the UE. The wake-up signal component 730 is capable of, configured to, or operable to support a means for receiving a wake-up signal from a network entity and via a cellular connection, the wake-up signal indicating that a message is available via the cellular connection. The connected message component 735 is capable of, configured to, or operable to support a means for receiving the message via the non-cellular connection based on operation of the wireless device in the connected mode with the UE.

In some examples, the monitoring component 745 is capable of, configured to, or operable to support a means for monitoring for the message via the non-cellular connection in accordance with a paging cycle, where the message is received via the non-cellular connection based on the monitoring.

In some examples, the wake-up signal component 730 is capable of, configured to, or operable to support a means for refraining from performing a wake-up procedure in response to the wake-up signal based on operation of the wireless device in the connected mode with the UE.

In some examples, the downlink message component 740 is capable of, configured to, or operable to support a means for additionally receiving the message via the cellular connection. In some examples, the decoder 750 is capable of, configured to, or operable to support a means for refraining from decoding the message additionally received via the cellular connection based on operation of the wireless device in the connected mode with the UE.

In some examples, the decoder 750 is capable of, configured to, or operable to support a means for refraining from decoding the message received via the non-cellular connection based on the message being decoded at the UE.

In some examples, the non-cellular connection includes a Bluetooth connection. In some examples, the wireless device includes a smart watch or a wearable device. In some examples, the smart watch or the wearable device is paired with the UE.

Additionally, or alternatively, the communications manager 720 may support wireless communication at a UE in accordance with examples as disclosed herein. In some examples, the connection component 725 is capable of, configured to, or operable to support a means for establishing a non-cellular connection between the UE and a wireless device, the non-cellular connection supporting operation of the wireless device in a connected mode with the UE. The downlink message component 740 is capable of, configured to, or operable to support a means for receiving a message via a cellular connection with a network entity, the message associated with the wireless device. In some examples, the connected message component 735 is capable of, configured to, or operable to support a means for transmitting the message via the non-cellular connection to the wireless device based on the message being associated with the wireless device and operation of the wireless device in the connected mode with the UE.

In some examples, to support transmitting the message via the non-cellular connection, the connected message component 735 is capable of, configured to, or operable to support a means for transmitting the message via the non-cellular connection in accordance with a paging cycle.

In some examples, the decoder 750 is capable of, configured to, or operable to support a means for decoding the message received via the cellular connection. In some examples, to support transmitting the message via the non-cellular connection, the connected message component 735 is capable of, configured to, or operable to support a means for transmitting the decoded message via the non-cellular connection to the wireless device.

In some examples, the forwarding component 755 is capable of, configured to, or operable to support a means for determining to forward the message to the wireless device based on the message including an indicator of the wireless device, where the message is transmitted via the non-cellular connection based on the determining.

In some examples, the non-cellular connection includes a Bluetooth connection. In some examples, the wireless device includes a smart watch or a wearable device. In some examples, the smart watch or the wearable device is paired with the UE.

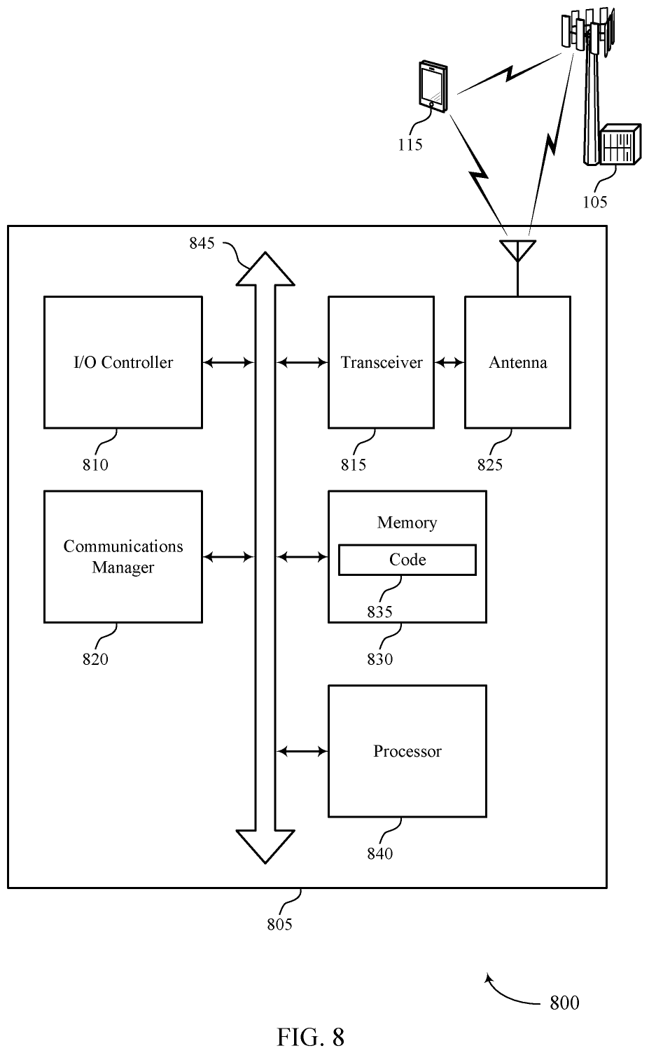

FIG. 8 shows a diagram of a system 800 including a device 805 that supports handling downlink messages at connected devices in accordance with one or more aspects of the present disclosure. The device 805 may be an example of or include the components of a device 505, a device 605, a UE 115, a wireless device, or any combination thereof as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable (e.g., processor-executable) code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting handling downlink messages at connected devices). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein.

The communications manager 820 may support wireless communication at a wireless device in accordance with examples as disclosed herein. For example, the communications manager 820 is capable of, configured to, or operable to support a means for establishing a non-cellular connection between the wireless device (e.g., the device 805) and a UE, the non-cellular connection supporting operation of the wireless device in a connected mode with the UE. The communications manager 820 is capable of, configured to, or operable to support a means for receiving a wake-up signal from a network entity and via a cellular connection, the wake-up signal indicating that a message is available via the cellular connection. The communications manager 820 is capable of, configured to, or operable to support a means for receiving the message via the non-cellular connection based on operation of the wireless device in the connected mode with the UE.

Additionally, or alternatively, the communications manager 820 may support wireless communication at a UE in accordance with examples as disclosed herein. For example, the communications manager 820 is capable of, configured to, or operable to support a means for establishing a non-cellular connection between the UE (e.g., the device 805) and a wireless device, the non-cellular connection supporting operation of the wireless device in a connected mode with the UE. The communications manager 820 is capable of, configured to, or operable to support a means for receiving a message via a cellular connection with a network entity, the message associated with the wireless device. The communications manager 820 is capable of, configured to, or operable to support a means for transmitting the message via the non-cellular connection to the wireless device based on the message being associated with the wireless device and operation of the wireless device in the connected mode with the UE.

By including or configuring the communications manager 820 in accordance with examples as described herein, the device 805 may support techniques for reduced power consumption, longer battery life, improved utilization of processing capability, or any combination thereof. For example, the device 805 (e.g., a wireless device operating in a connected mode with a UE 115) may refrain from receiving downlink messages via a cellular connection, refrain from decoding downlink messages received via the cellular connection, or both to reduce power consumption and processing resources associated with downlink message reception. Such techniques may extend the battery life for the device 805 (e.g., a smart watch or other wireless device).

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of handling downlink messages at connected devices as described herein, or the at least one processor 840 and the at least one memory 830 may be otherwise configured to, individually or collectively, perform or support such operations.

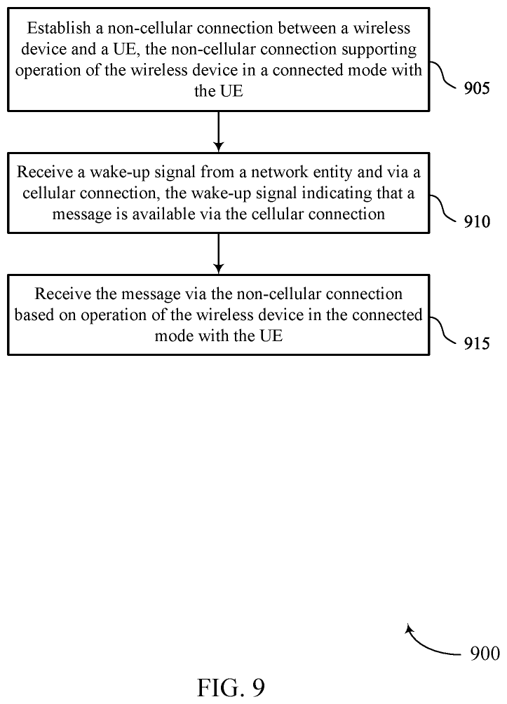

FIG. 9 shows a flowchart illustrating a method 900 that supports handling downlink messages at connected devices in accordance with aspects of the present disclosure. The operations of the method 900 may be implemented by a wireless device (e.g., a UE 115) or its components as described herein. For example, the operations of the method 900 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 905, the method may include establishing a non-cellular connection between the wireless device and a UE, the non-cellular connection supporting operation of the wireless device in a connected mode with the UE. The operations of 905 may be performed in accordance with examples as disclosed herein. In some examples, aspects of the operations of 905 may be performed by a connection component 725 as described with reference to FIG. 7.

At 910, the method may include receiving a wake-up signal from a network entity and via a cellular connection, the wake-up signal indicating that a message is available via the cellular connection. The operations of 910 may be performed in accordance with examples as disclosed herein. In some examples, aspects of the operations of 910 may be performed by a wake-up signal component 730 as described with reference to FIG. 7.

At 915, the method may include receiving the message via the non-cellular connection based on operation of the wireless device in the connected mode with the UE. The operations of 915 may be performed in accordance with examples as disclosed herein. In some examples, aspects of the operations of 915 may be performed by a connected message component 735 as described with reference to FIG. 7.

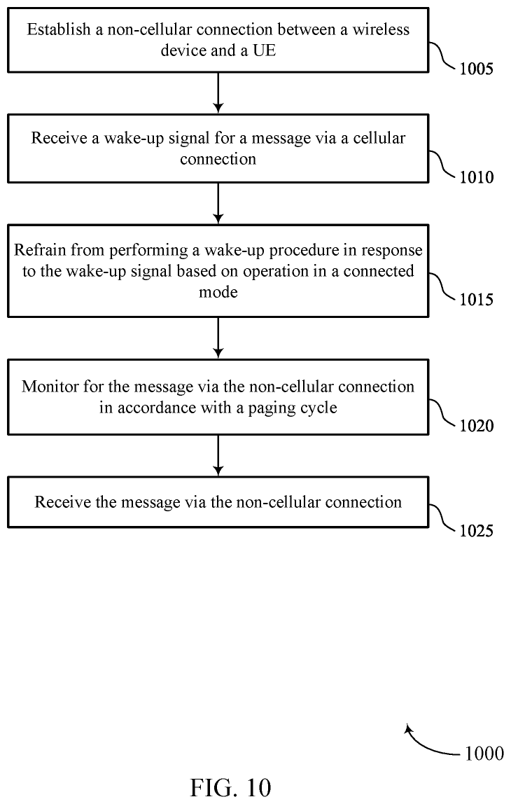

FIG. 10 shows a flowchart illustrating a method 1000 that supports handling downlink messages at connected devices in accordance with aspects of the present disclosure. The operations of the method 1000 may be implemented by a wireless device (e.g., a UE 115) or its components as described herein. For example, the operations of the method 1000 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1005, the method may include establishing a non-cellular connection between the wireless device and a UE, the non-cellular connection supporting operation of the wireless device in a connected mode with the UE. The operations of 1005 may be performed in accordance with examples as disclosed herein. In some examples, aspects of the operations of 1005 may be performed by a connection component 725 as described with reference to FIG. 7.

At 1010, the method may include receiving a wake-up signal from a network entity and via a cellular connection, the wake-up signal indicating that a message is available via the cellular connection. The operations of 1010 may be performed in accordance with examples as disclosed herein. In some examples, aspects of the operations of 1010 may be performed by a wake-up signal component 730 as described with reference to FIG. 7.

At 1015, the method may include refraining from performing a wake-up procedure in response to the wake-up signal based on operation of the wireless device in the connected mode with the UE. The operations of 1015 may be performed in accordance with examples as disclosed herein. In some examples, aspects of the operations of 1015 may be performed by a wake-up signal component 730 as described with reference to FIG. 7.

At 1020, the method may include monitoring for the message via the non-cellular connection in accordance with a paging cycle. The operations of 1020 may be performed in accordance with examples as disclosed herein. In some examples, aspects of the operations of 1020 may be performed by a monitoring component 745 as described with reference to FIG. 7.

At 1025, the method may include receiving the message via the non-cellular connection based on operation of the wireless device in the connected mode with the UE and based on the monitoring. The operations of 1025 may be performed in accordance with examples as disclosed herein. In some examples, aspects of the operations of 1025 may be performed by a connected message component 735 as described with reference to FIG. 7.

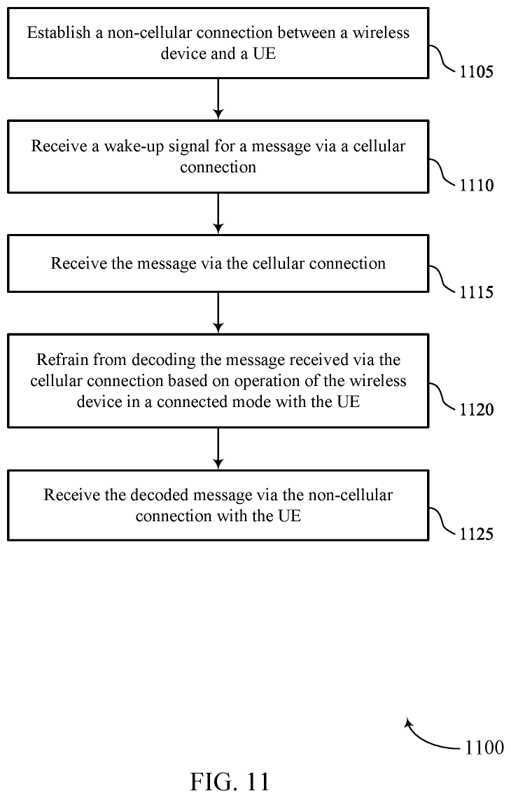

FIG. 11 shows a flowchart illustrating a method 1100 that supports handling downlink messages at connected devices in accordance with aspects of the present disclosure. The operations of the method 1100 may be implemented by a wireless device (e.g., a UE 115) or its components as described herein. For example, the operations of the method 1100 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1105, the method may include establishing a non-cellular connection between the wireless device and a UE, the non-cellular connection supporting operation of the wireless device in a connected mode with the UE. The operations of 1105 may be performed in accordance with examples as disclosed herein. In some examples, aspects of the operations of 1105 may be performed by a connection component 725 as described with reference to FIG. 7.

At 1110, the method may include receiving a wake-up signal from a network entity and via a cellular connection, the wake-up signal indicating that a message is available via the cellular connection. The operations of 1110 may be performed in accordance with examples as disclosed herein. In some examples, aspects of the operations of 1110 may be performed by a wake-up signal component 730 as described with reference to FIG. 7.

At 1115, the method may include receiving the message via the cellular connection. The operations of 1115 may be performed in accordance with examples as disclosed herein. In some examples, aspects of the operations of 1115 may be performed by a downlink message component 740 as described with reference to FIG. 7.

At 1120, the method may include refraining from decoding the message received via the cellular connection based on operation of the wireless device in the connected mode with the UE. The operations of 1120 may be performed in accordance with examples as disclosed herein. In some examples, aspects of the operations of 1120 may be performed by a decoder 750 as described with reference to FIG. 7.

At 1125, the method may include receiving the message via the non-cellular connection based on the operation of the wireless device in the connected mode with the UE. The operations of 1125 may be performed in accordance with examples as disclosed herein. In some examples, aspects of the operations of 1125 may be performed by a connected message component 735 as described with reference to FIG. 7.

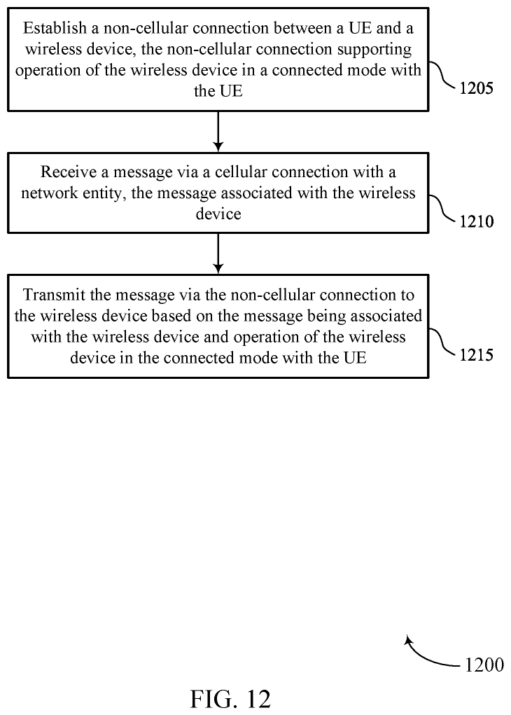

FIG. 12 shows a flowchart illustrating a method 1200 that supports handling downlink messages at connected devices in accordance with aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include establishing a non-cellular connection between the UE and a wireless device, the non-cellular connection supporting operation of the wireless device in a connected mode with the UE. The operations of 1205 may be performed in accordance with examples as disclosed herein. In some examples, aspects of the operations of 1205 may be performed by a connection component 725 as described with reference to FIG. 7.

At 1210, the method may include receiving a message via a cellular connection with a network entity, the message associated with the wireless device. The operations of 1210 may be performed in accordance with examples as disclosed herein. In some examples, aspects of the operations of 1210 may be performed by a downlink message component 740 as described with reference to FIG. 7.

At 1215, the method may include transmitting the message via the non-cellular connection to the wireless device based on the message being associated with the wireless device and operation of the wireless device in the connected mode with the UE. The operations of 1215 may be performed in accordance with examples as disclosed herein. In some examples, aspects of the operations of 1215 may be performed by a connected message component 735 as described with reference to FIG. 7.

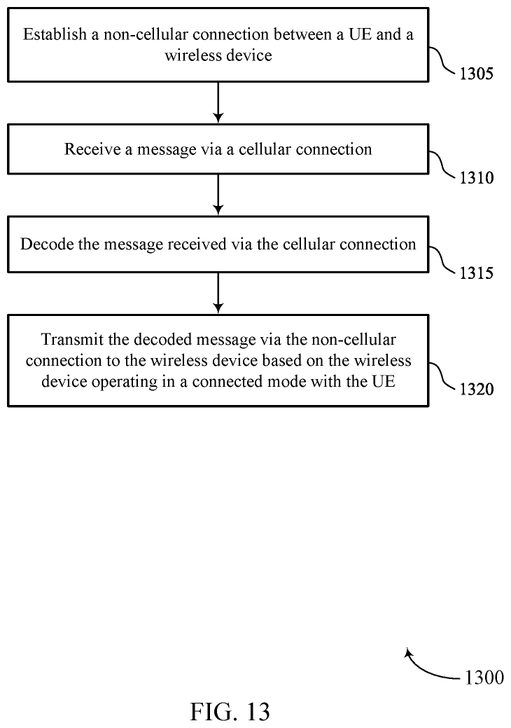

FIG. 13 shows a flowchart illustrating a method 1300 that supports handling downlink messages at connected devices in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include establishing a non-cellular connection between the UE and a wireless device, the non-cellular connection supporting operation of the wireless device in a connected mode with the UE. The operations of 1305 may be performed in accordance with examples as disclosed herein. In some examples, aspects of the operations of 1305 may be performed by a connection component 725 as described with reference to FIG. 7.

At 1310, the method may include receiving a message via a cellular connection with a network entity, the message associated with the wireless device. The operations of 1310 may be performed in accordance with examples as disclosed herein. In some examples, aspects of the operations of 1310 may be performed by a downlink message component 740 as described with reference to FIG. 7.

At 1315, the method may include decoding the message received via the cellular connection. The operations of 1315 may be performed in accordance with examples as disclosed herein. In some examples, aspects of the operations of 1315 may be performed by a decoder 750 as described with reference to FIG. 7.

At 1320, the method may include transmitting the decoded message via the non-cellular connection to the wireless device based on the message being associated with the wireless device and operation of the wireless device in the connected mode with the UE. The operations of 1320 may be performed in accordance with examples as disclosed herein. In some examples, aspects of the operations of 1320 may be performed by a connected message component 735 as described with reference to FIG. 7.

The following provides an overview of aspects of the present disclosure:

Aspect 1: A method for wireless communication by a wireless device, comprising: establishing a non-cellular connection between the wireless device and a UE, the non-cellular connection supporting operation of the wireless device in a connected mode with the UE; receiving a wake-up signal from a network entity and via a cellular connection, the wake-up signal indicating that a message is available via the cellular connection; and receiving the message via the non-cellular connection based at least in part on the operation of the wireless device in the connected mode with the UE.

Aspect 2: The method of aspect 1, further comprising: monitoring for the message via the non-cellular connection in accordance with a paging cycle, wherein the message is received via the non-cellular connection based at least in part on the monitoring.

Aspect 3: The method of any of aspects 1 through 2, further comprising: refraining from performing a wake-up procedure in response to the wake-up signal based at least in part on the operation of the wireless device in the connected mode with the UE.

Aspect 4: The method of any of aspects 1 through 2, further comprising: additionally receiving the message via the cellular connection; and refraining from decoding the message additionally received via the cellular connection based at least in part on the operation of the wireless device in the connected mode with the UE.

Aspect 5: The method of any of aspects 1 through 4, further comprising: refraining from decoding the message received via the non-cellular connection based at least in part on the message being decoded at the UE.

Aspect 6: The method of any of aspects 1 through 5, wherein the non-cellular connection comprises a Bluetooth connection.

Aspect 7: The method of any of aspects 1 through 6, wherein the wireless device comprises a smart watch or a wearable device, wherein the smart watch or the wearable device is paired with the UE.

Aspect 8: A method for wireless communication by a UE, comprising: establishing a non-cellular connection between the UE and a wireless device, the non-cellular connection supporting operation of the wireless device in a connected mode with the UE; receiving a message via a cellular connection with a network entity, the message associated with the wireless device; and transmitting the message via the non-cellular connection to the wireless device based at least in part on the message being associated with the wireless device and the operation of the wireless device in the connected mode with the UE.

Aspect 9: The method of aspect 8, wherein transmitting the message via the non-cellular connection comprises: transmitting the message via the non-cellular connection in accordance with a paging cycle.

Aspect 10: The method of any of aspects 8 through 9, further comprising: decoding the message received via the cellular connection, wherein transmitting the message via the non-cellular connection comprises: transmitting the decoded message via the non-cellular connection to the wireless device.

Aspect 11: The method of any of aspects 8 through 10, further comprising: determining to forward the message to the wireless device based at least in part on the message comprising an indicator of the wireless device, wherein the message is transmitted via the non-cellular connection based at least in part on the determining.

Aspect 12: The method of any of aspects 8 through 11, wherein the non-cellular connection comprises a Bluetooth connection.

Aspect 13: The method of any of aspects 8 through 12, wherein the wireless device comprises a smart watch or a wearable device, wherein the smart watch or the wearable device is paired with the UE.

Aspect 14: A wireless device, comprising: one or more memories storing processor-executable code; and one or more processors coupled with the one or more memories and individually or collectively operable to execute the code to cause the wireless device to perform a method of any of aspects 1 through 7.

Aspect 15: A wireless device for wireless communication, comprising at least one means for performing a method of any of aspects 1 through 7.

Aspect 16: A non-transitory computer-readable medium storing code for wireless communication, the code comprising instructions executable by a processor to perform a method of any of aspects 1 through 7.

Aspect 17: A UE, comprising: one or more memories storing processor-executable code; and one or more processors coupled with the one or more memories and individually or collectively operable to execute the code to cause the UE to perform a method of any of aspects 8 through 13.

Aspect 18: A UE for wireless communication, comprising at least one means for performing a method of any of aspects 8 through 13.

Aspect 19: A non-transitory computer-readable medium storing code for wireless communication, the code comprising instructions executable by a processor to perform a method of any of aspects 8 through 13.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
establish a non-cellular connection between the wireless device and a user equipment (UE), the non-cellular connection supporting operation of the wireless device in a connected mode with the UE;
receive a wake-up signal from a network entity and via a cellular connection, the wake-up signal indicating that a message is available via the cellular connection; and
receive the message via the non-cellular connection based at least in part on the operation of the wireless device in the connected mode with the UE.

2. The wireless device of claim 1, wherein the one or more processors are individually or collectively further operable to execute the code to cause the wireless device to:
monitor for the message via the non-cellular connection in accordance with a paging cycle, wherein the message is received via the non-cellular connection based at least in part on the monitoring.

3. The wireless device of claim 1, wherein the one or more processors are individually or collectively further operable to execute the code to cause the wireless device to:
refrain from performing a wake-up procedure in response to the wake-up signal based at least in part on the operation of the wireless device in the connected mode with the UE.

4. The wireless device of claim 1, wherein the one or more processors are individually or collectively further operable to execute the code to cause the wireless device to:
additionally receive the message via the cellular connection; and
refrain from decoding the message additionally received via the cellular connection based at least in part on the operation of the wireless device in the connected mode with the UE.

5. The wireless device of claim 1, wherein the one or more processors are individually or collectively further operable to execute the code to cause the wireless device to:
refrain from decoding the message received via the non-cellular connection based at least in part on the message being decoded at the UE.

6. The wireless device of claim 1, wherein the non-cellular connection comprises a Bluetooth connection.

7. The wireless device of claim 1, wherein the wireless device comprises a smart watch or a wearable device, wherein the smart watch or the wearable device is paired with the UE.

8. A user equipment (UE), comprising:
one or more memories storing processor-executable code; and
one or more processors coupled with the one or more memories and individually or collectively operable to execute the code to cause the UE to:
establish a non-cellular connection between the UE and a wireless device, the non-cellular connection supporting operation of the wireless device in a connected mode with the UE;
receive a message via a cellular connection with a network entity, the message associated with the wireless device; and
transmit the message via the non-cellular connection to the wireless device based at least in part on the message being associated with the wireless device and the operation of the wireless device in the connected mode with the UE.

9. The UE of claim 8, wherein, to transmit the message via the non-cellular connection, the one or more processors are individually or collectively operable to execute the code to cause the UE to:
transmit the message via the non-cellular connection in accordance with a paging cycle.

10. The UE of claim 8, wherein the one or more processors are individually or collectively further operable to execute the code to cause the UE to:
decode the message received via the cellular connection, wherein, to transmit the message via the non-cellular connection, the one or more processors are individually or collectively operable to execute the code to cause the UE to:
transmit the decoded message via the non-cellular connection to the wireless device.

11. The UE of claim 8, wherein the one or more processors are individually or collectively further operable to execute the code to cause the UE to:
determine to forward the message to the wireless device based at least in part on the message comprising an indicator of the wireless device, wherein the message is transmitted via the non-cellular connection based at least in part on the determining.

12. The UE of claim 8, wherein the non-cellular connection comprises a Bluetooth connection.

13. The UE of claim 8, wherein the wireless device comprises a smart watch or a wearable device, wherein the smart watch or the wearable device is paired with the UE.

14. A method for wireless communication by a wireless device, comprising:
establishing a non-cellular connection between the wireless device and a user equipment (UE), the non-cellular connection supporting operation of the wireless device in a connected mode with the UE;
receiving a wake-up signal from a network entity and via a cellular connection, the wake-up signal indicating that a message is available via the cellular connection; and
receiving the message via the non-cellular connection based at least in part on the operation of the wireless device in the connected mode with the UE.

15. The method of claim 14, further comprising:
monitoring for the message via the non-cellular connection in accordance with a paging cycle, wherein the message is received via the non-cellular connection based at least in part on the monitoring.

16. The method of claim 14, further comprising:
refraining from performing a wake-up procedure in response to the wake-up signal based at least in part on the operation of the wireless device in the connected mode with the UE.

17. The method of claim 14, further comprising:
additionally receiving the message via the cellular connection; and
refraining from decoding the message additionally received via the cellular connection based at least in part on the operation of the wireless device in the connected mode with the UE.

18. The method of claim 14, further comprising:
refraining from decoding the message received via the non-cellular connection based at least in part on the message being decoded at the UE.

19. The method of claim 14, wherein the non-cellular connection comprises a Bluetooth connection.

20. The method of claim 14, wherein the wireless device comprises a smart watch or a wearable device, wherein the smart watch or the wearable device is paired with the UE.
